(19) United States
(12) Patent Application Publication
(10) Pub. No.: US 2012/0307880 A1
(43) Pub. Date: Dec. 6, 2012

(54) MIXED-PHASE REAL TIME AUTOMATIC ROOM EQUALIZATION SYSTEM

(75) Inventors: Ulrich Horbach, Canyon Country, CA (US); James Hall, Los Altos, CA (US)

(73) Assignee: Harman International Industries, Incorporated, Northridge, CA (US)

(21) Appl. No.: 12/895,413

(22) Filed: Sep. 30, 2010

(51) Int. Cl. H04L 27/01

(52) U.S. Cl. 375/230

(57) ABSTRACT

A system is provided for determining mixed-phased real time room equalization that employs crossover filters for splitting the incoming spectrum and also re-uses the cross-over filters in the equalization filter.

### BACKGROUND

1. Field of the Invention

The present invention relates to acoustic equalization and more particularly to generation of correction filter spectra for use in finite impulse response filters.

2. Related Art

Typically, a digital signal processor (DSP) is employed to improve the perceived acoustics in small rooms and cars with varying success. The previous approaches have used infinite impulse response (IIR) cascade filters to process audio signals. The previous DSP approaches suffer from complicated filter design procedures and signal processing paths, and correct only a magnitude of audio signal but not phase response errors that adversely impact stereo image stability. Other issues with known DSP approaches include the inability to provide real-time correction with audio signals, such as music is playing.

Further drawbacks of previous IIR-based approaches to automatic equalization are stability problems, quantization noise, and limited accuracy of reaching the required target responses. In many cases, a higher than necessary number of filter sections (biquads) must be provided, since the length of the processing path is not known beforehand. Joint optimization of individual filter sections is a comprehensive optimization task, prohibiting real-time processing in most cases.

Accordingly, there is a need for a simple, low cost approach for applying mixed-phased real time automatic room equalization.

### SUMMARY

In view of the above, an approach for mixed-phase real time automatic room equalization is needed. Source spectrum and captured acoustic spectrum may be time aligned with a cross correlation function and then an updated EQ filter may be computed using both a high frequency signal path and low frequency signal path in real time, in parallel. This approach is especially useful when the listening spot changes while music is playing or the driver is handing over a microphone to a passenger in a vehicle. It is to be understood that the features mentioned above and those yet to be explained below may be employed not only in the respective combinations indicated, but also in other combinations or in isolation without departing from the scope of the invention.

Other devices, apparatus, systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The description below may be better understood by referring to the following figures. The components in the figures are not necessarily to scale, emphasis instead being placed upon illustrating the principles of the invention. In the figures, like reference numerals designate corresponding parts throughout the different views.

FIG. 1 is a block diagram of a digital signal processor (DSP) in accordance with one example of an implementation of the mixed-phased real time automatic room equalization system (MPRTARES).

FIG. 2 is a flow diagram of one example of an equalization (EQ) filter approach that may be performed by the DSP of FIG. 1.

FIG. 3 is a flow diagram of one example of the generation of the EQ filter responses during setup of the DSP of FIG. 1.

FIG. 4 is a graph of one example of a logarithmic sweep test signal that may be generated in accordance with the invention.

FIG. 5 is a graph of a time domain representations of one example of a high frequency analysis filter in accordance with the invention.

FIG. 6 is a graph of a time domain representation of one example of a low frequency analysis filter in accordance with the invention.

FIG. 7 is one example of a flow diagram of the steps of the high frequency EQ in accordance with the invention.

FIG. 8 is a graph of one example of a high frequency EQ greater than 1 kHz in accordance with the invention.

FIG. 9 is a graph of one example of a high and low frequency target functions in accordance with the invention.

FIG. 10 is a graph of one example of a final EQ filter with target and crossover function applied in accordance with the invention.

FIG. 11 is one example of a flow diagram of the steps of the low frequency EQ in accordance with the invention.

FIG. 12 is a graph of one example of a low frequency EQ below 1 kHz in accordance with the invention.

FIG. 13 is a graph of one example of a band limited acoustic impulse responses before and after mixed phase EQ in accordance with the invention.

FIG. 14 is a block diagram of one example of a real-time EQ application in accordance with the invention.

### DETAILED DESCRIPTION

It is to be understood that the following description of examples of implementations are given only for the purpose of illustration and are not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. One or more functional blocks or units may also be implemented in a common circuit, chip, circuit element or unit.

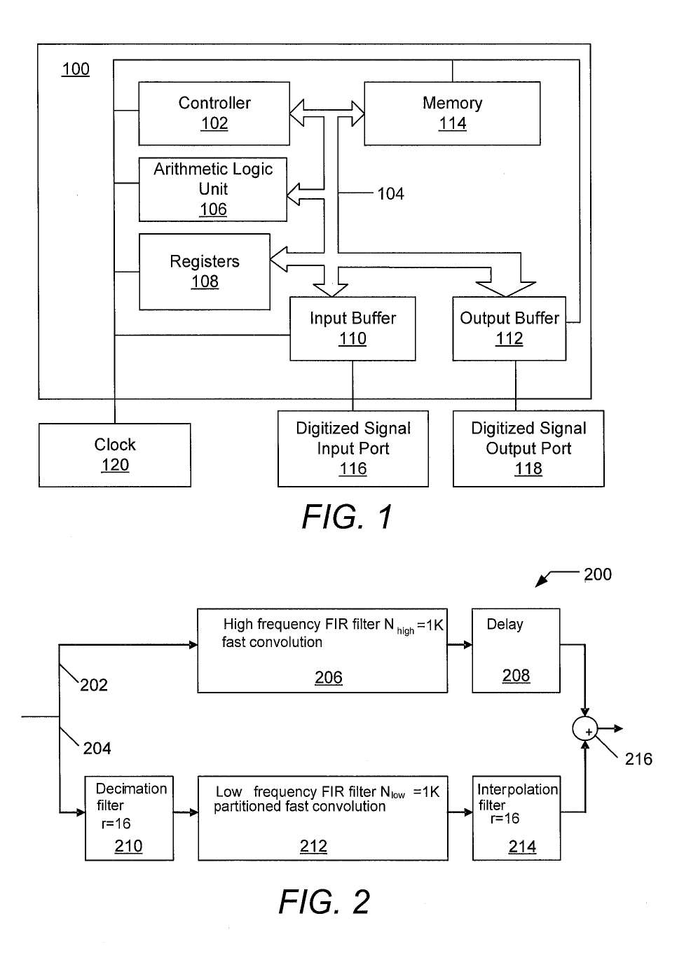

In FIG. 1, a block diagram of a digital signal processor (DSP) 100 in accordance with one example of an implementation of the mixed-phased real time automatic room equalization system (MPRTARES) is shown. DSP 100 is depicted in a simplified form with a core controller (or processing unit) 102 connected by internal data and address busses 104 that may connected an arithmetic logic unit 106, registers, 108, input buffer 110, output buffer 112, and memory 114. The memory 114 may be internal to the DSP 100, external to the DSP 100, or a mixture of both internal and external memory. The input buffer 110 may be coupled to a digitized signal input port 116 and the output buffer 112 may be coupled to a digitized signal output port 118. In other implementations, it is understood that analog-to-digital (A/D) converters and digital-to-analog (D/A) converters may be implemented internal to the DSP 100, enabling analog signals to be received and output by the DSP 100. A clock 120 may provide one or more clock signals to the DSP 100. The DSP 100 may use the clock signals to generate additional clock and control signals internal to the DSP 100.

The memory 114 may be used to store instructions that are executed by the controller 102 and arithmetic logic unit 104 when processing digitized signals. Filters and other devices may also be implemented in the DSP 100 as instructions that are used to process the digitized signals and configure/control hardware elements of the DSP 100. Furthermore, in other implementations, microprocessors or other controllers besides a DSP 100 may be employed to control the processing of digital signals, such as application specific controllers (ASIC), analog circuits, or discreet digital circuits acting as a state machine.

Turning to FIG. 2, a flow diagram 200 of an equalization (EQ) filter approach performed by the DSP 100 of FIG. 1 in accordance with one example of an implementation of the MPRTARES. A signal is provided via two parallel signal paths 202 and 204. The first signal path passes through a high frequency FIR (Finite Impulse Response) filter 206. The high frequency of the signal is typically above f_{c}=1 kHz. A delay 208 may be added to the signal traversing the first signal path after the high frequency filter 206. The delay compensates for the usually higher signal latency in the second signal path 204 (the low frequency path). This latency in the second signal path 204 may be minimized by applying partitioned fast convolution techniques, where multiple Fast Fourier Transforms (FFTs) of smaller lengths are used and accumulated.

The second signal path 204 is at a lower frequency, typically equal to or below f_{c}. In order to obtain the lower frequency resolution in the second signal path 204, a decimation of the signal (lower sampling rate) may occur, such as with decimation filter 210, where the decimation rate=16, for example. The decimated signal may then pass through a low-frequency filter 212. The low-frequency filter 212 operates at the lower sample rate. Typical sub-sampling factors are 4 . . . 16. For example, if the sample rate of the system is 48 kHz, the low-frequency filter 212 might run at a sample frequency of 3 kHz. The signal is then interpolated by an interpolation filter 214 where the interpolation rate=16. In some implementations, the sample rate reduction may be implemented with decimation and interpolation FIR filters. The two signal paths may be combined after the delay 208 and interpolation 214 by a signal combiner or summing node 216.

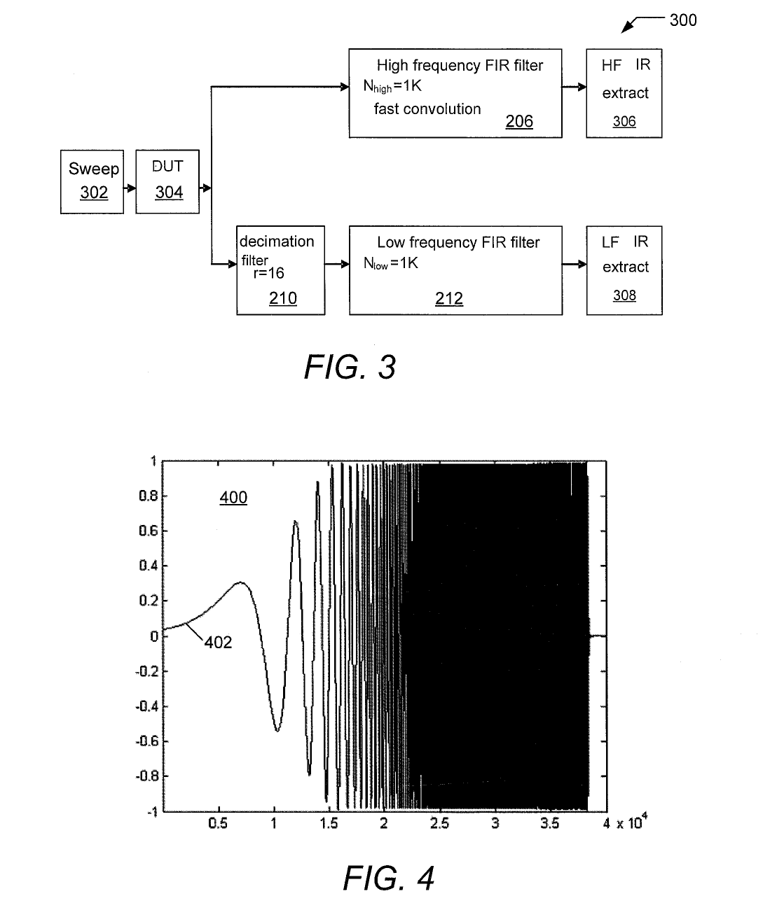

In FIG. 3 is a flow diagram 300 of the generation of the EQ filter responses determined during setup of DSP 100 of FIG. 1 in accordance with one example of an implementation of the MPRTARES is depicted. The same approach as described in FIG. 2 may be employed to determine the EQ filter coefficients. A logarithmic sweep generator 302 may generate an excitation signal with a typical length of 40000 samples, covering a frequency range 20 Hz . . . 20 kHz as an excitation signal for a device under test (DUT) 304.

FIG. 4 illustrates a graph 400 of an excitation signal 402 covering the frequency range 20 Hz . . . 20 kHz in accordance with one example of an implementation. An output signal from the DUT 304 is transmitted along the parallel paths to the high frequency FIR filter 206 and decimated by decimation filter 210. The impulse responses (IR) of the DUT to the excitation signal for the high frequency path 202 and low frequency path 204 respectively, may be determined (or extracted) by applying analysis filter coefficients in the high frequency FIR filter 206 and low frequency FIR filter 212. The high frequency (HF) IR extractor 306 and low frequency (LF) IR extractor 308 identify the IR that result for both the high frequency path and low frequency paths.

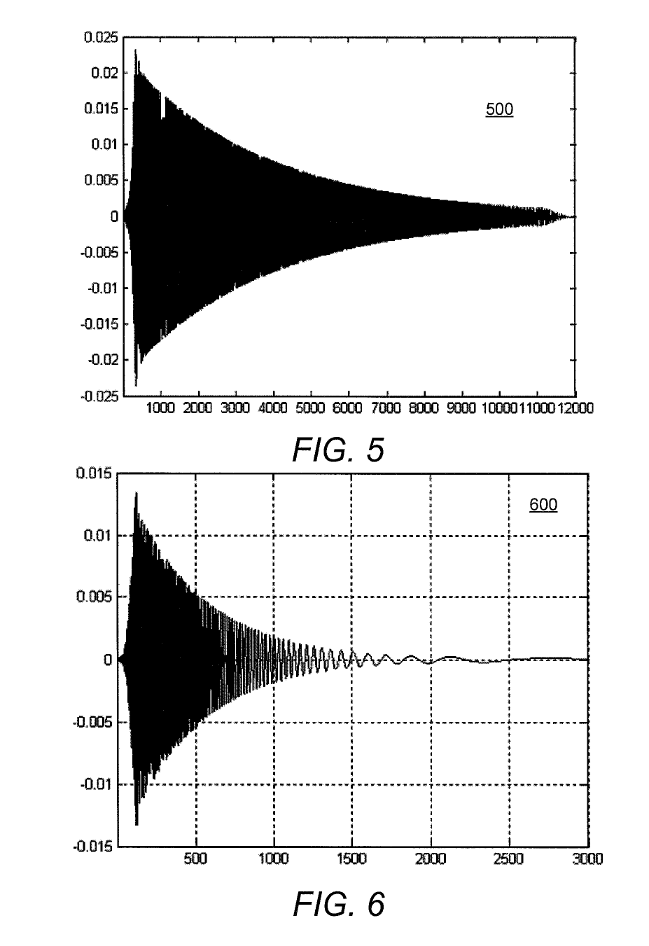

The high frequency analysis filter spectrum may be the spectrum of linear phase high-pass of corner frequency f_{c}, typically of length 1K (1024 samples), divided by the spectrum of the logarithmic sweep signal. A time domain representation of the high frequency analysis filter in accordance with an example implementation is shown in graph 500 of FIG. 5.

The low frequency analysis filter spectrum may be the spectrum of a linear phase low pass filter of a corner frequency above f_{c}, for example 1.5 times f_{c}, typically of length 1K (1024 samples), divided by the spectrum of the logarithmic sweep signal, and resampled to the decimated sample rate of typically 3 kHz. A time domain representation of the low frequency analysis filter in accordance with an example implementation is shown in graph 600 of FIG. 6.

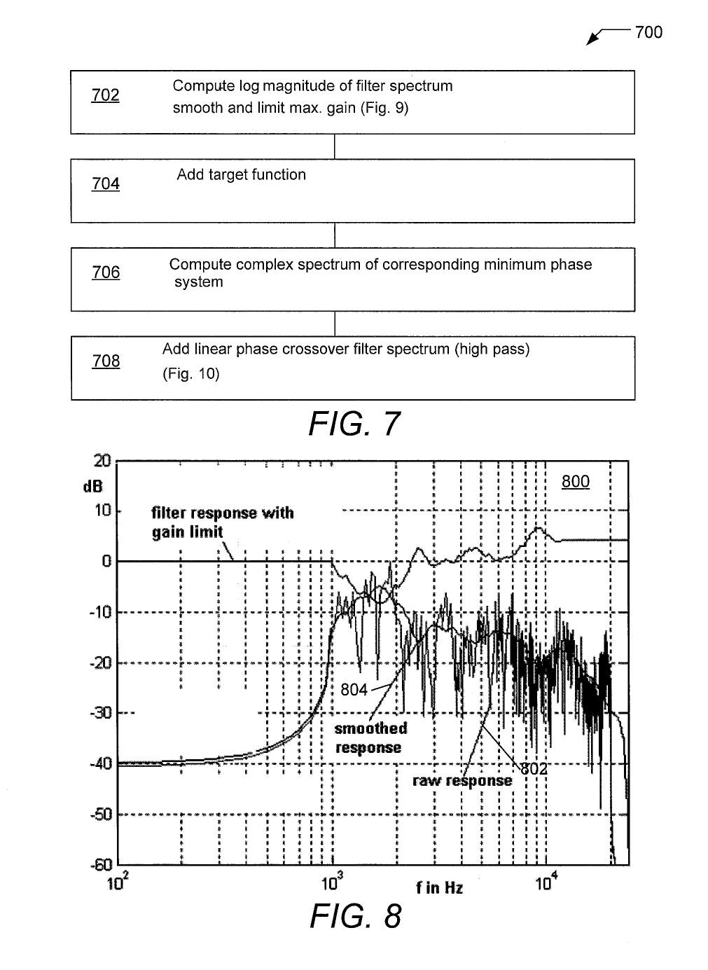

Turning to FIG. 7, one example of a flow diagram 700 of steps of the high frequency EQ 206 executed by the DSP 100 is provided. The flow diagram 700 starts with the log magnitude spectrum of the high frequency impulse response (IR) as determined using the approach shown in FIG. 3, being smoothed 702. In the graph 800 of FIG. 8, both the raw response 802 and smoothed response 804 may be seen in accordance with an example implementation. The smoothing of the raw response 802 may occur with the spectrum F(i), with i=1, . . . , N/2, being generated using an N point FFT, where for example, N=8192 and a smoothing factor sm₁, resulting in Fs(i)=mean{F(i/sm1) . . . F(i*sm1)}. Typically, the smoothing factor sm₁ may be equal to approximately 1.05-1.2. The equalization filter may then be computed by inverting the sign of the smoothed response, restricting its range to a pre-determined frequency band, for example 1 kHz . . . 12 kHz, and applying a gain limit if necessary.

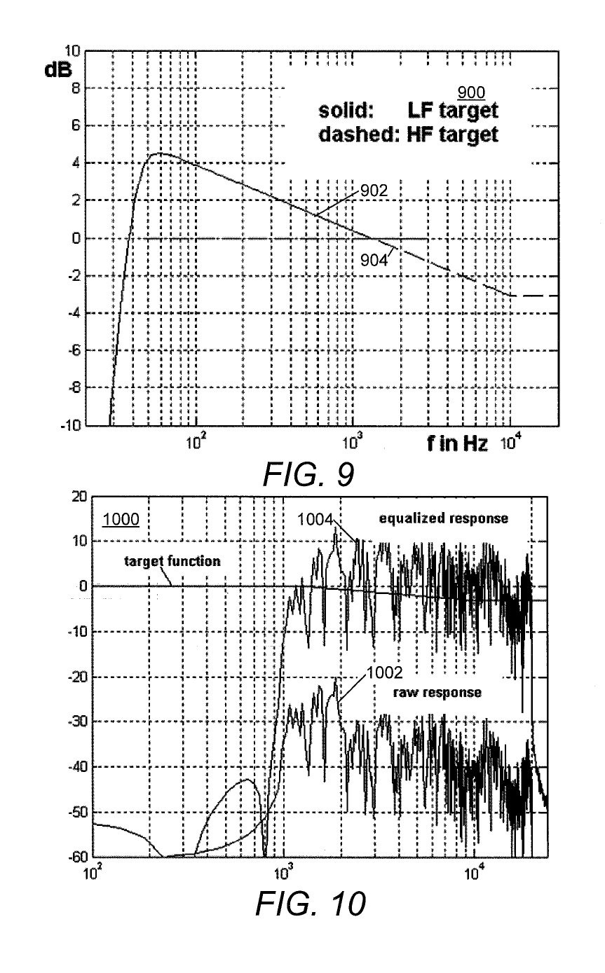

In most implementations, including a vehicle, the desired target function for the acoustic response is not flat. FIG. 9 illustrates one example of a graph 900 that depicts a typical target function (high frequency target 902 and low frequency target 904) in accordance with one example of an implementation of the MPRTARES. The target function contains a bass boost of about 4 dB at 50 Hz, with linear descent up to 10 kHz (−3 dB). The target function may be split into an high frequency part and applied to the high frequency EQ filter 206, along with a low frequency part applied to the low frequency EQ filter 212 as shown in FIG. 2. This target function may be simply added to the EQ response in the log-magnitude domain 704. The complex filter spectrum of a corresponding minimum phase system is then calculated for magnitude response, using the Hilbert transform 706. Finally, the previous linear phase crossover high pass filter is added, typically with a passband frequency of f_{c}=1 kHz, and a stop band frequency of 1.5*f_{c} in the current example. By using these design parameters, a sufficient stop band attenuation may be achieved with a filter length of typically n=64. A low filter order is desirable to keep overall latency at a minimum in the MPRTARES. Turning to FIG. 10, a graph 1000 of one example of the raw response 1002 and the final filter response 1004 with the target function and high pass filter is depicted.

In FIG. 11, an example flow diagram 1100 of the additional steps of the low frequency EQ is shown. The additional steps of the low-frequency EQ filter include, as compared with the high frequency flow diagram of FIG. 7, the application of phase correction below a pre-defined transition frequency fₜ. This is desirable because humans are particularly sensitive to inter-aural phase differences at low frequencies (<1 kHz), which are used to localize sound sources. At high frequencies, only level differences are used. Hence, only magnitude EQ is required at high frequencies.

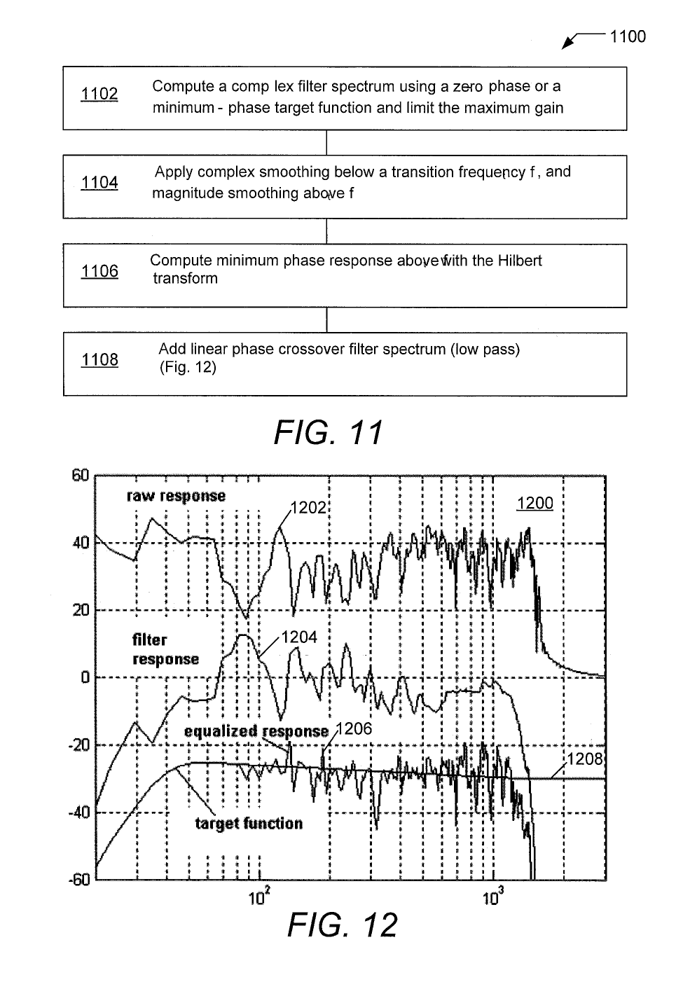

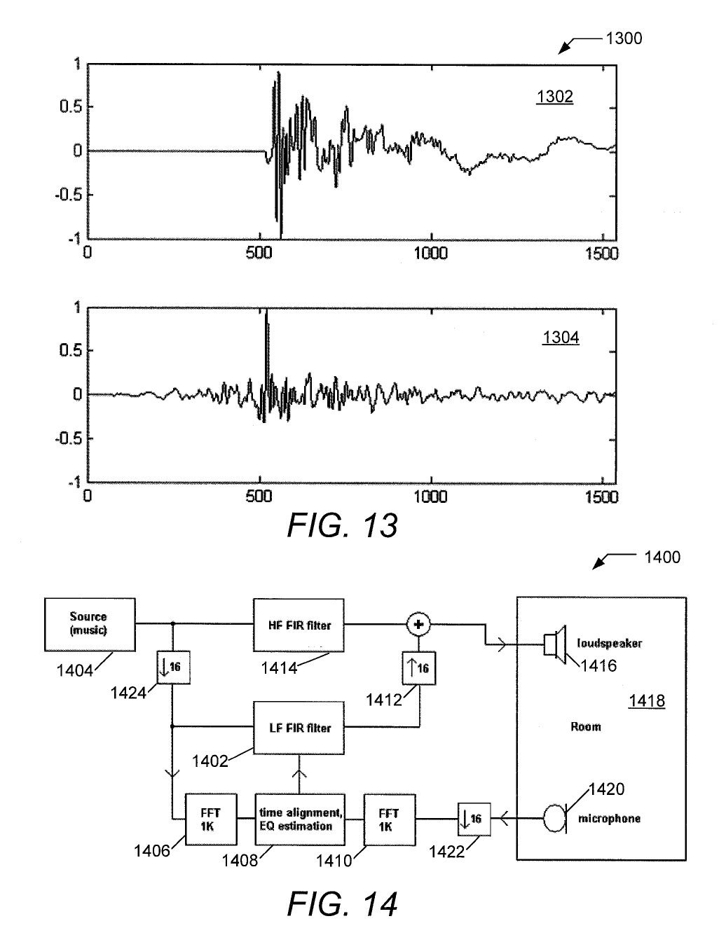

The flow diagram 1100 starts with a complex filter spectrum that is computed 1102, by dividing a zero-phase (real-valued) target function, such as shown in FIG. 9, or its corresponding minimum-phase version, by the spectrum of the LF IR as previously determined (see FIG. 3). The smoothing of the complex spectral values is then performed up to a prescribed frequency fₜ 1104 (typically in the range of 500 Hz-800 Hz), and smoothing of the absolute values above that frequency. To restrict the maximum filter gain to a value Aₘₐₓ, a gain-limiter may be applied, by replacing the complex spectral values U₍ᵢ₎ at a specific frequency sample “i” by their gain-limited versions U(i)/|U(i)|*Aₘₐₓ. Above fₜ, a minimum-phase response is computed 1106 (similar to 706, FIG. 7). Finally, a linear phase low pass spectrum is multiplied with the complex filter spectrum 1108. The filter degree and slope are identical to the high frequency crossover function, such that their sum yields unity. FIG. 12 illustrates one example of a graph of the low frequency EQ below 1 kHz in accordance with one example of an implementation of the MPRTARES. The raw response 1202, filter response 1204, equalized response 1206, and the target function 1208 can be seen in graph 1200. Turning to FIG. 13, FIG. 13 illustrates a graph 1300 of the band limited acoustic impulse responses before 1302 and after 1304 mixed phase EQ in accordance with one example of an implementation of the invention.

FIG. 14 is a block diagram 1400 of a real-time EQ application in accordance with one example of an implementation of the MPRTARES. An update of the low-frequency EQ FIR filter 1402 may be constantly performed while an audio signal (i.e. music) from a source 1404 is playing, using the audio signal itself as a test signal. Source spectrum and captured acoustic spectrum (using FFTs of size 1K) 1406 and 1410 are time aligned by using their cross correlation function 1408, then an updated EQ filter is computed using the technique as outlined above and the low frequency FIR filter is updated 1402, which then has its output interpolated 1412 and combined with the output of the high frequency FIR filter 1414. The combined signals may then be passed to a loudspeaker 1416 located in the listening room 1418. A microphone 1420 may be located in the listening room 1418 to capture the acoustic spectrum and pass it through a decimation filter 1422, similar to the decimation filter 1424 the source spectrum passes through. The MPRTARES approach is useful in cases where the listening spot changes while music is playing, for example the listener is moving in a room, or the driver is handing over the microphone to a passenger and address the need for a simplified filter design that replaces IIR cascade with a single-stage, parallel FIR filter structure that operates in the frequency domain. The MPRTARES approach is also able to correct not only magnitude, but phase response errors as well, below a predetermined frequency (typically 500-1000 Hz), to better match stereo channels and improve stereo image stability. The MPRTARES approach also enables real-time correction that constantly updates the system performance while audio signals are present, not just during setup or configuration of the system.

The foregoing description of implementations has been presented for purposes of illustration and description. It is not exhaustive and does not limit the claimed inventions to the precise form disclosed. Modifications and variations are possible in light of the above description or may be acquired from practicing examples of the invention. The claims and their equivalents define the scope of the invention.

What is claimed is:

1. A method for a mixed-phase real-time automatic room equalization (MPRTARE) filter, comprising;
dividing an input signal into a first signal and a second signal;
filtering the first signal with a high frequency finite impulse response (FIR) filter and results in a first filtered signal;
filtering the second signal with a low frequency FIR filter and results in a second filtered signal; and
combining the first filtered signal and the second filtered signal resulting in an equalized signal.

2. The MPRTARE method of claim 1, includes,
extracting a high frequency impulse response from the first filtered signal in response to an excitation signal being the input signal in order to determine high frequency equalization filter coefficients; and
extracting a low frequency impulse response from the second filtered signal in response to the excitation signal in order to determine low frequency equalization filter coefficients.

3. The MPRTARE method of claim 2, includes, generating a logarithmic sweep signal that results in the excitation signal when passed through a device under test.

4. The MPRTARE method of claim 3, where the logarithmic sweep signal covers a frequency range of 20 Hz to 20 kHz.

5. The MPRTARE method of claim 1, includes decimating the second signal with a decimation filter prior to the low frequency FIR filter.

6. The MPRTARE method of claim 5, where the decimation filter has a sampling rate of 3 kHz.

7. The MPRTARE method of claim 5, includes interpolating the second filter signal with an interpolation filter.

8. The MPRTARE method of claim 1, includes delaying the first filtered signal with a delay.

9. The MPRTARE method of claim 1, includes updating continuously coefficients used by the low-frequency EQ FIR filter in response the input signal, where the input signal is an audio signal.

10. The MPRTARE method of claim 9, where the audio signal is a music audio signal.

11. A mixed-phase real-time automatic room equalization (MPRTARE) filter, comprising;
an input signal divided into a first signal and a second signal;
a high frequency finite impulse response (FIR) filter that filters the first signal and results in a first filtered signal;
a low frequency FIR filter that filters the second signal and results in a second filtered signal; and
a combiner that combines the first filtered signal and the second filtered signal and results in an equalized signal.

12. The MPRTARE filter of claim 11, includes an excitation signal being the input signal and results in high frequency equalization filter coefficients being determined from the first filtered signal and low frequency equalization filter coefficients being determined from the second filtered signal.

13. The MPRTARE filter of claim 12, includes a sweep generator that generates a logarithmic sweep signal that results in the excitation signal when passed through a device under test.

14. The MPRTARE filter of claim 13, where the logarithmic sweep signal covers a frequency range of 20 Hz to 20 kHz.

15. The MPRTARE filter of claim 11, includes a decimation filter that decimates the second signal prior to the low frequency FIR filter.

16. The MPRTARE filter of claim 15, where the decimation filter has a sampling rate of 3 kHz.

17. The MPRTARE filter of claim 15, includes an interpolation filter that interpolates the second filter signal.

18. The MPRTARE filter of claim 11, includes a delay that delays the first filtered signal.

19. The MPRTARE filter of claim 11, includes an audio signal is the input signal and coefficients used by the low-frequency EQ FIR filter in response the input signal are continuously updated.

20. The MPRTARE filter of claim 9, where a music audio signal is the audio signal.
